(19) United States
(12) Patent Application Publication
(10) Pub. No.: US 2012/0304761 A1
(43) Pub. Date: Dec. 6, 2012

(54) FLUID LEVEL MEASUREMENT APPARATUS AND SYSTEM

(75) Inventors: Isao Miyagawa, Kariya-city (JP); Hiroshi Hashimoto, Obu-city (JP)

(73) Assignee: DENSO CORPORATION, Kariya-city (JP)

(21) Appl. No.: 13/483,621

(22) Filed: May 30, 2012

(30) Foreign Application Priority Data
Jun. 3, 2011 (JP) 2011-125521

(51) Int. Cl. G01F 23/26

(52) U.S. Cl. 73/304 C

(57) ABSTRACT

A fluid level measurement system includes a fluid level sensor, a voltage application circuit, and a measurement circuit. The fluid level sensor includes a rotating member rotating depending on a fluid level, a supporting member for rotatably supporting the rotating member, and a variable resistor having a resistance depending on a rotation angle of the rotating member. The application circuit applies an AC voltage to the resistor. The measurement circuit measures the fluid level based on the resistance. A resistive portion of the resistor is held by the supporting member and extends around the rotation center of the rotating member. A movable portion of the resistor is held by the rotating member and has a contact surface made of mainly gold. When the rotating member rotates, the movable portion moves along the resistive portion with the contact surface in contact with the resistive portion.

### CROSS REFERENCE TO RELATED APPLICATION

This application is based on Japanese Patent Application No. 2011-125521 filed on Jun. 3, 2011, the disclosure of which is incorporated herein by reference.

### TECHNICAL FIELD

The present disclosure relates to a fluid level measurement apparatus and system configured to measure the level of a fluid in a container.

### BACKGROUND

A fluid level measurement apparatus including a variable resistor having an electrical resistance varying depending on the level of a fluid is known. For example, a fluid level measurement apparatus disclosed in US 2004/0226367A corresponding to JP-2004-340756A includes an arm holder rotating according to the level of a fuel in a fuel tank, a frame supported to the fuel tank to rotatably support the arm holder, and a variable resistor having an electrical resistance varying depending on an angle of rotation of the arm holder. The variable resistor disclosed in US 2004/0226367A includes a resistive member and a metal plate. The resistive member extends around the center of rotation of the arm holder. The metal plate moves along the resistive member with the rotation of the arm holder while being kept in contact with the resistive member.

A fuel level measurement module disclosed in U.S. Pat. No. 5,172,007 includes a variable resistor having a resistance wire formed in a plastic board and a wiper made of silver or the like. The wiper moves along the resistance wire. In addition, the fuel level measurement module includes a waveform generator for applying a rectangular wave voltage to the variable resistor and a processor for measuring the level of a fluid based on an electrical resistance of a variable resistor.

When a voltage is applied to such a variable resistor in a fluid such as fuel, a surface of the plate or the wiper may be ionized and dissolved in the fuel depending on a polarity of the voltage so that galvanic corrosion can occur. In the fuel level measurement module, the rectangular wave voltage applied to the variable resistor is an alternating-current (AC) voltage. Therefore, ions dissolved from the surface of the wiper into the fuel can return to the surface of the wiper when the polarity of the voltage is reversed. Thus, the galvanic corrosion can be prevented or reduced.

In the fuel level measurement module, as a frequency of the rectangular wave voltage is higher, the ions dissolved into the fuel become more likely to return to the wiper. However, since the wiper is made of silver, which is relatively likely to deteriorate, it is difficult to maintain good conduction between the wiper and the resistance wire. Therefore, it is likely that the rectangular wave voltage applied by the waveform generator to the variable resistor becomes distorted and unstable between the wiper and the resistance wire. For this reason, when the frequency of the rectangular wave voltage is increased, it is difficult for the processor to accurately measure the electrical resistance of the variable resistor.

In contrast, as the frequency of the rectangular wave voltage is lower, an interval at which the polarity of the voltage is reversed is longer. Since the ions dissolved from the surface of the wiper into the fuel moves far away from the wiper during the longer interval, the ions are less likely to return to the wiper when the polarity of the voltage is reversed. Therefore, it is difficult to reduce the galvanic corrosion of the wiper to a sufficient degree. Recently, an alcohol fuel containing alcohol has been widely used. The galvanic corrosion of the wiper is more likely to occur in the alcohol fuel due to its high conductivity. If the galvanic corrosion of the wiper occurs, the electrical resistance of the variable resistor may inaccurately correspond to the level of the fuel. Therefore, measurement accuracy of the fuel level measurement module may degrade after long-term use of the fuel level measurement module.

### SUMMARY

In view of the above, it is an object of the present disclosure to provide a fluid level measurement apparatus and system configured to maintain its measurement accuracy even after long-term use.

According to an aspect of the present disclosure, a fluid level measurement apparatus includes a rotating member, a supporting member, and a variable resistor. The rotating member rotates depending on a level of a fluid in a container. The supporting member is supported by the container and rotatably supports the rotating member. The variable resistor has an electrical resistance varying depending on an angle of rotation of the rotating member. The variable resistor includes a resistive portion and a movable portion. The resistive portion is held by the supporting member and extends around a center of rotation of the rotating member. The movable portion is held by the rotating member and has a contact surface made mainly of gold. When the rotating member rotates, the movable portion moves along the resistive portion with the contact surface in contact with the resistive portion.

According to an aspect of the present disclosure, a fluid level measurement system includes the fluid level measurement apparatus, a voltage application circuit, and a measurement circuit. The voltage application circuit applies an alternating current voltage to the variable resistor of the fluid level measurement. The measurement circuit measures the level of the fluid based on the electrical resistance of the variable resistor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram of a fluid level measurement system according to a first embodiment of the present disclosure;

FIG. 2 is a diagram illustrating a mechanical configuration of a fluid level sensor according to the first embodiment;

FIG. 3 is a diagram illustrating a cross-sectional view taken along the line in FIG. 2;

FIGS. 4A-4E are timing diagrams of the fluid level measurement system according to the first embodiment;

FIG. 5 is a block diagram of a fluid level measurement system according to a second embodiment of the present disclosure;

FIGS. 6A-6E are timing diagrams of the fluid level measurement system according to the second embodiment;

FIGS. 7A-7E are timing diagrams of a fluid level measurement system according to a third embodiment of the present disclosure;

FIGS. 8A-8E are timing diagrams of a fluid level measurement system according to a modification of the second embodiment;

FIG. 9 is a timing diagram of a fluid level measurement system according to a modification of the first embodiment, and

FIG. 10 is a timing diagram of a fluid level measurement system according to a modification of the third embodiment.

### DETAILED DESCRIPTION

### First Embodiment

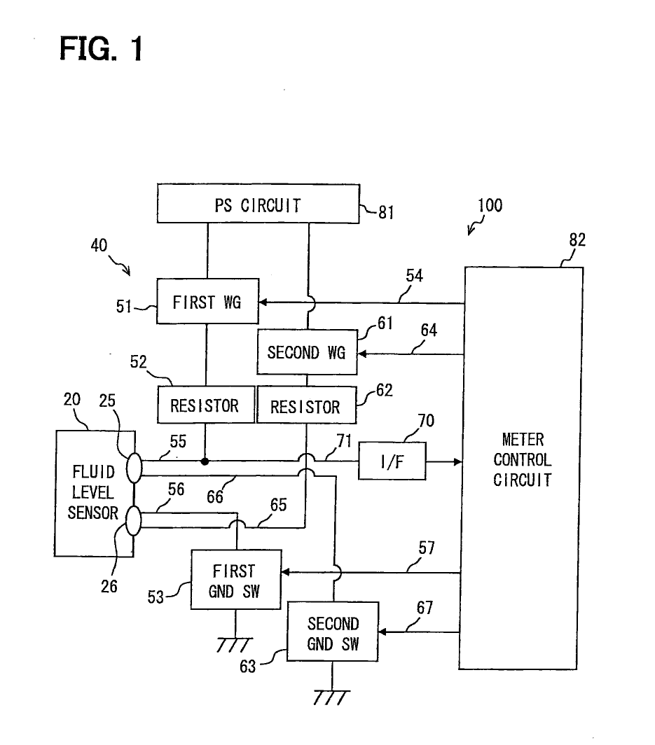

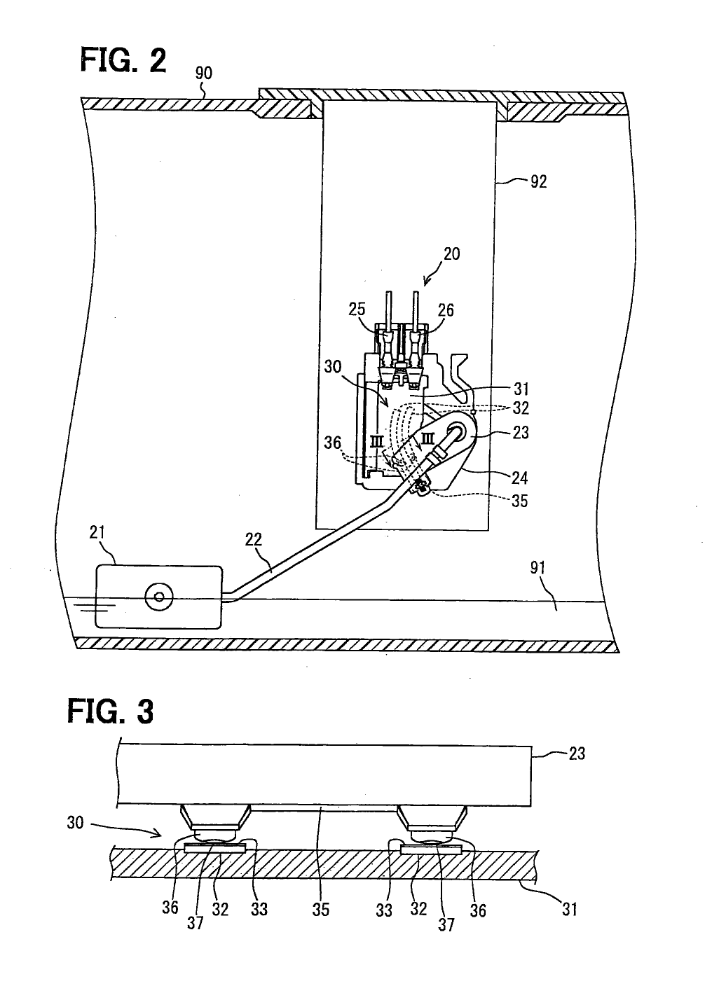

FIG. 1 is a block diagram illustrating an electrical configuration of a fluid level measurement system 100 according to a first embodiment of the present disclosure. FIG. 2 is a diagram illustrating a mechanical configuration of a fluid level sensor 20 according to the first embodiment. FIG. 3 is a diagram illustrating a cross-sectional view taken along the line III-III in FIG. 2. The fluid level measurement system 100 includes the fluid level sensor 20, a voltage application circuit 40, and a meter control circuit 82. The fluid level sensor 20 is installed in a fuel tank 90 of a vehicle. The voltage application circuit 40 and the meter control circuit 82 are connected to the fluid level sensor 20. A level of a fuel 91 in the fuel tank 90 is measured by the fluid level measurement system 100 and displayed to a user of the vehicle through a fuel meter (not shown) of a combination meter assembly equipped with the meter control circuit 82. According to the first embodiment, the fuel 91 contains alcohol such as methanol or ethanol.

The fluid level sensor 20 outputs an electrical resistance depending on the level of the fuel 91 in the fuel tank 90 to the meter control circuit 82. The fluid level sensor 20 includes a float 21, a float arm 22, an arm holder 23, a housing 24, a power terminal 25, a ground terminal 26, and a variable resistor 30.

The float 21 is made of a material, such as expanded ebonite, having a lower specific gravity than the fuel 91. Thus, the float 21 can float at the level of the fuel 91. The float arm 22 is shaped like a circular shaft and made of a metal material such as stainless steel. A first end of the float arm 22 is coupled to the float 21. A second end of the float arm 22 is coupled to the arm holder 23. The arm holder 23 is made of a material having a good resistance to oil and solvent and having a good mechanical property. For example, the arm holder 23 can be made of polyoxymethylene (POM) resin. The arm holder 23 is rotatably coupled to the housing 24 and rotates according to the level of the fuel 91 in the fuel tank 90.

The housing 24 can be made of POM resin or the like. The housing 24 rotatably supports the arm holder 23. The housing 24 is fixed to a wall surface of a fuel pump module 92 and supported to the fuel tank 90 through the fuel pump module 92. The power terminal 25 and the ground terminal 26 are made of conductive metal material. A voltage is applied through the power terminal 25 and the ground terminal 26 to the variable resistor 30 from the voltage application circuit 40, which is located outside the fluid level sensor 20.

An electrical resistance of the variable resistor 30 varies depending on an angle of rotation of the arm holder 23, i.e., depending on the level of the fuel 91. The voltage applied from the voltage application circuit 40 to the variable resistor 30 is a trapezoidal alternating-current (AC) voltage. The variable resistor 30 includes a printed circuit board 31 and a conductor 35.

The printed circuit board 31 is shaped like a plate and made of epoxide resin, for example. The printed circuit board 31 is accommodated in and supported by the housing 24. A first surface of the printed circuit board 31 faces the arm holder 23. A pair of resistor patterns 32 is formed on the first surface of the printed circuit board 31. The resistor patterns 32 are spaced from each other and extend in an arc shape around the center of rotation of the arm holder 23. Each resistor pattern 32 is a small resistive element arranged in an arc shape. One resistor pattern 32 is connected to the power terminal 25, and the other resistor pattern 32 is connected to the ground terminal 26. Each resistor pattern 32 has an exposed surface facing the arm holder 23. The exposed surface of the resistor pattern 32 is hereinafter called a resistance surface 33. According to the first embodiment, the resistance surface 33 is made of silver alloy containing palladium, for example.

The conductor 35 is made of metal material, such as copper alloy, having good electrical conductivity. The conductor 35 connects the resistor patterns 32 so that the power terminal 25 and the ground terminal 26 can be electrically connected. A first surface of the arm holder 23 faces the printed circuit board 31. The conductor 35 is supported on the first surface of the arm holder 23. Thus, the conductor 35 rotates with the arm holder 23. The conductor 35 has a pair of wipers 36, each of which is in contact with a corresponding one of the resistor patterns 32. Each wiper 36 is biased to (i.e., pressed against) the corresponding resistor pattern 32 by elasticity of the conductor 35. The wiper 36 has a contact surface 37 in contact with the resistance surface 33 of the resistor pattern 32. The contact surface 37 is made mainly of gold. For example, the contact surface 37 can be formed on the wiper 36 by heating and melting metal material containing 95 percent or more of gold, preferably 99 percent or more of gold. The contact surface 37 is curved in a convex manner toward the resistor pattern 32. When the arm holder 23 rotates, the wiper 36 moves along the resistor pattern 32 in such a manner that the contact surface 37 of the wiper 36 is kept in contact with the resistance surface 33 of the resistor pattern 32.

The fluid level sensor 20 operates as follows. The float 21 moves up and down according to the level of the fuel 91. The reciprocating movement of the float 21 is converted by the float arm 22 into a rotational movement and transmitted to the arm holder 23. Thus, the arm holder 23 rotates relative to the housing 24 according to the level of the fuel 91 in the fuel tank 90. Accordingly, the conductor 35 and the resistor pattern 32 work in conjunction with each other to indicate the electrical resistance depending on the angle of rotation of the arm holder 23, i.e., the level of the fuel 91. Therefore, the level of the fuel 91 can be measured as the electrical resistance of the variable resistor 30.

As shown in FIG. 1, the voltage application circuit 40 includes a first waveform generator 51, a first resistor 52, a first ground switch 53, a second waveform generator 61, a second resistor 62, and a second ground switch 63.

The first waveform generator 51 is connected to a power line 55.

The power line 55 connects the power terminal 25 of the fluid level sensor 20 to a power supply circuit 81 that supplies a voltage of about 5 volts, for example. The first waveform generator 51 is connected through a signal line 54 to the meter control circuit 82 and receives a first control signal from the meter control circuit 82. The first control signal is turned ON and OFF so that the first waveform generator 51 can apply a trapezoidal voltage to the power terminal 25 of the fluid level sensor 20 through the power line 55.

The second waveform generator 61 is connected to a power line 65. The power line 65 connects the ground terminal 26 of the fluid level sensor 20 to the power supply circuit 81. The second waveform generator 61 is connected through a signal line 64 to the meter control circuit 82 and receives a second control signal from the meter control circuit 82. The second control signal is turned ON and OFF so that the second waveform generator 61 can apply a trapezoidal voltage to the ground terminal 26 of the fluid level sensor 20 through the power line 65.

Each of the first resistor 52 and the second resistor 62 is a passive element having a predetermined electrical resistance. The first resistor 52 is connected to the power line 55 between the first waveform generator 51 and the power terminal 25. The second resistor 62 is connected to the power line 65 between the second waveform generator 61 and the ground terminal 26. The first resistor 52 and the second resistor 62 stabilize potentials of the power terminal 25 and the ground terminal 26, respectively.

The first ground switch 53 is connected to the ground line 56. For example, the first ground switch 53 is a field-effect transistor (FET). The ground line 56 allows the ground terminal 26 to be connected to a predetermined first ground potential. The gate of the first ground switch 53 is connected through a signal line 57 to the meter control circuit 82 so that a third control signal can be applied from the meter control circuit 82 to the gate of the first ground switch 53. When the third control signal is turned ON, the first ground switch 53 is turned ON so that conduction between the source and the drain of the first ground switch 53 can occur. Thus, the ground terminal 26 is connected through the ground line 56 to the first ground potential.

The second ground switch 63 is connected to the ground line 66. For example, the second ground switch 63 is a field-effect transistor (FET). The ground line 66 allows the power terminal 25 to be connected to a predetermined second ground potential. The gate of the second ground switch 63 is connected through a signal line 67 to the meter control circuit 82 so that a fourth control signal can be applied from the meter control circuit 82 to the gate of the second ground switch 63. When the fourth control signal is turned ON, the second ground switch 63 is turned ON so that conduction between the source and the drain of the second ground switch 63 can occur. Thus, the power terminal 25 is connected through the ground line 66 to the second ground potential.

The meter control circuit 82 is part of the combination meter assembly and includes a processor that executes instructions from programs. The meter control circuit 82 is connected to the voltage application circuit 40 through the signal lines 54, 57, 64, and 67 and controls the voltage application circuit 40 to control the application of the AC voltage to the fluid level sensor 20.

The meter control circuit 82 is connected to the power line 55 through an interface (I/F) 70 and a detection line 71. The meter control circuit 82 measures the potential of the power terminal 25 through the power line 55, the detection line 71, and the interface 70. The meter control circuit 82 prestores information regarding a relationship between the potential of the power terminal 25 and the level of the fuel 91. The meter control circuit 82 measures the potential of the power terminal 25, which varies depending on the electrical resistance of the variable resistor 30, and determines the level of the fuel 91 by checking the measured potential of the power terminal 25 against the prestored information. Thus, the meter control circuit 82 measures the level of the fuel 91 based on the electrical resistance of the variable resistor 30.

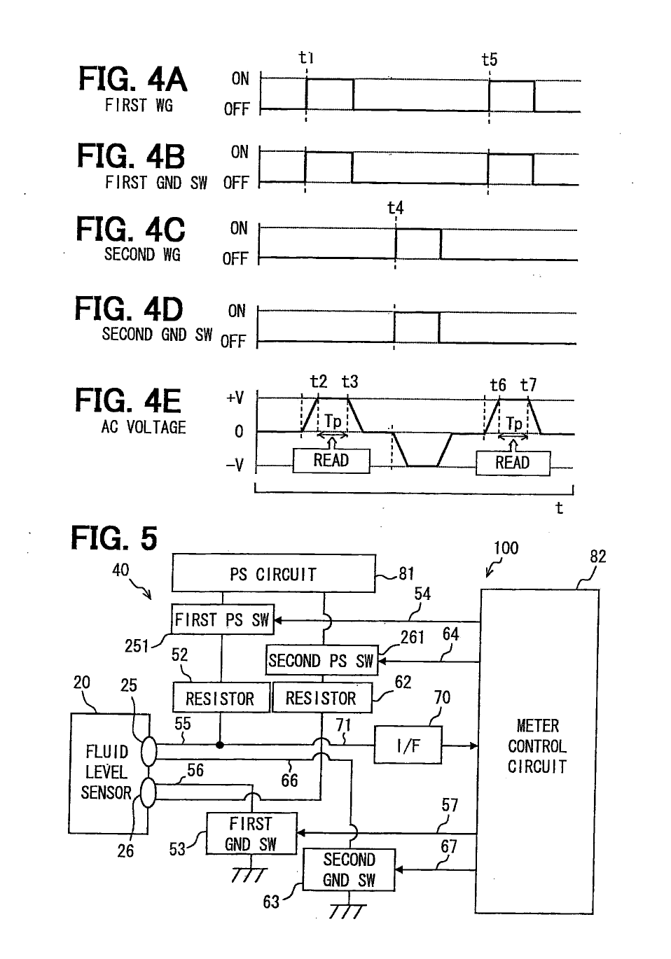

The operation of the fluid level measurement system 100 to measure the level of the fuel 91 is described below with reference to FIGS. 4A-4E. FIGS. 4A-4E are timing diagrams of the fluid level measurement system 100.

As shown in FIGS. 4A and 4B, at a time t1, the meter control circuit 82 switches the first control signal, which is supplied through the signal line 54 to the first waveform generator 51, and the third control signal, which is supplied through the signal line 57 to the first ground switch 53, from OFF to ON. Thus, as shown in FIG. 4E, the AC voltage applied between the power terminal 25 and the ground terminal 26 of the fluid level sensor 20 rises to a positive side. According to the first embodiment, when the potential of the power terminal 25 is higher than the potential of the ground terminal 26, the AC voltage is defined as positive. In contrast, when the potential of the power terminal 25 is lower than the potential of the ground terminal 26, the AC voltage is defined as negative.

The AC voltage applied between the power terminal 25 and the ground terminal 26 of the fluid level sensor 20 starts to rise at the time t1 and reaches a predetermined positive peak value at a time t2. The AC voltage holds the positive peak value during a peak period Tp from the time t2 to a time t3. Then, as shown in FIGS. 4A and 4B, at the time t3, the meter control circuit 82 switches the first control signal and the third control signal from ON to OFF. Thus, as shown in FIG. 4E, the AC voltage applied between the power terminal 25 and the ground terminal 26 of the fluid level sensor 20 drops from the positive side.

Then, as shown in FIGS. 4C and 4D, at a predetermined time t4 after the time t3, the meter control circuit 82 switches the second control signal, which is supplied through the signal line 64 to the second waveform generator 61, and the fourth control signal, which is supplied through the signal line 67 to the second ground switch 63, from OFF to ON. Thus, as shown in FIG. 4E, the AC voltage applied between the power terminal 25 and the ground terminal 26 of the fluid level sensor 20 drops to the negative side and reaches a predetermined negative peak value. Then, when the meter control circuit 82 switches the second control signal and the fourth control signal from ON to OFF, the AC voltage starts to rise from the negative side.

Then, at a predetermined time t5 after the second control signal and the fourth control signal are switched OFF, the meter control circuit 82 switches the first control signal and the third control signal from OFF to ON. Thus, as shown in FIG. 4E, the AC voltage applied between the power terminal 25 and the ground terminal 26 of the fluid level sensor 20 reaches the positive peak value at a time t6 and holds the positive peak value during the peak period Tp from the time t6 to a time t7.

The meter control circuit 82 repeatedly controls the control signals in the above manner so that the AC voltage applied by the voltage application circuit 40 to the variable resistor 30 of the fluid level sensor 20 can have a trapezoidal waveform. The AC voltage has a zero section where the AC voltage is zero between a positive section where the AC voltage is positive and a negative section where the AC voltage is negative. For example, a frequency of the AC voltage can range from about 10 kHz to about 50 kHz. Preferably, the frequency of the AC voltage can be about 10 kHz, where noise is less likely to occur. The meter control circuit 82 measures the present level of the fuel 91 in the fuel tank 90 by detecting the potential of the power terminal 25 within the peak period Tp.

According to the first embodiment, since the contact surface 37 is made mainly of gold, the contact surface 37 is less likely to deteriorate even in alcohol fuel, which contains alcohol and has high conductivity. Therefore, good conduction between the resistor pattern 32 and the contact surface 37 can be maintained. Accordingly, it is less likely that the waveform of the AC voltage applied by the voltage application circuit 40 to the variable resistor 30 becomes distorted. Thus, the waveform of the AC voltage can be stabilized. Due to this AC voltage waveform stabilization effect, even when the frequency of the AC voltage is increased, the meter control circuit 82 can accurately measure the potential of the power terminal 25, i.e., the level of the fuel 91, based on the electrical resistance of the variable resistor 30.

As the frequency of the AC voltage is higher, an interval, at which the polarity of the potential of the variable resistor 30 reverses, becomes shorter. Accordingly, the peak period Tp becomes shorter. Thus, it is less likely that a small amount of ions dissolved from the contact surface 37 into the fuel 91 moves far away from the contact surface 37 before the polarity of the potential of the variable resistor 30 reverses. Therefore, the dissolved ions can return to the contact surface 37, when the polarity of the potential of the variable resistor 30 reverses. For this reason, galvanic corrosion of the contact surface 37 is much less likely to occur.

As described above, the combination of the contact surface 37 made of mainly gold and the application of the AC voltage to the variable resistor 30 can effectively reduce the galvanic corrosion of the contact surface 37 while maintaining the stable contact of the contact surface 37 regardless of the reduction in the peak period Tp. Therefore, the electrical resistance indicated by the fluid level sensor 20 accurately corresponds to the level of the fuel 91 even after the fluid level sensor 20 is used for a long time. Accordingly, the measurement accuracy of the fluid level measurement system 100 can be maintained even after the fluid level measurement system 100 is used for a long time.

Further, according to the first embodiment, the meter control circuit 82 detects the potential of the power terminal 25 within the peak period Tp where the absolute value of the AC voltage applied to the variable resistor 30 is maximized. In such an approach, the meter control circuit 82 can accurately detect the potential of the power terminal 25, which depends on the electrical resistance of the variable resistor 30. Thus, the meter control circuit 82 can accurately measure the level of the fuel 91.

Further, according to the first embodiment, the application of the AC voltage by the voltage application circuit 40 to the variable resistor 30 is controlled by the meter control circuit 82. In such an approach, it is ensured that the meter control circuit 82 can measure the level of the fuel 91 within the peak period Tp even when the frequency of the AC voltage is high. Thus, the galvanic corrosion can be reduced by increasing the frequency of the AC voltage. Since the galvanic corrosion is reduced, the electrical resistance of the variable resistor 30 can accurately correspond to the level of the fuel 91 even after the fluid level sensor 20 is used for a long time. Therefore, the measurement accuracy of the fluid level measurement system 100 can be maintained even after the fluid level measurement system 100 is used for a long time.

Assuming that the AC voltage applied to the variable resistor 30 changes sharply in a short time, conduction noise may be induced in the fluid level measurement system 100. As a result of the conduction noise, radiation noise may be produced. These noises can affect the measurement of the level of the fuel 91 by the meter control circuit 82.

To prevent such noises, according to the first embodiment, the AC voltage has a trapezoidal waveform. That is, the AC voltage has a rising time and a falling time. The rising time is a time necessary for the AC voltage to rise (or fall) from a reference value (e.g., zero) to the positive peak value (or the negative peak value). The falling time is a time necessary for the AC voltage to fall (or rise) from the positive peak value (or the negative peak value) to the reference value. That is, there is a time lag when the AC voltage changes between the reference value and the peak value with reference to the reference value. In such an approach, the conduction noise and the radiation noise due to the sharply change in the AC voltage are reduced so that the meter control circuit 82 can accurately measure the level of the fuel 91. Therefore, the measurement accuracy of the fluid level measurement system 100 can be maintained high.

Further, the AC voltage is trapezoidal, the peak value of the AC voltage is held during the peak period Tp. Therefore, it is ensured that the meter control circuit 82 can measure the level of the fuel 91 within the peak period Tp even when the frequency of the AC voltage is high. Thus, the galvanic corrosion of the conductor 35 can be reduced by increasing the frequency of the AC voltage. Since the galvanic corrosion is reduced, the electrical resistance indicated by the fluid level sensor 20 can accurately correspond to the level of the fuel 91 even after the fluid level sensor 20 is used for a long time. Therefore, the measurement accuracy of the fluid level measurement system 100 can be maintained even after the fluid level measurement system 100 is used for a long time.

The combination of the contact surface 37 made of mainly gold and the application of the AC voltage to the variable resistor 30 can effectively reduce the galvanic corrosion of the contact surface 37, in particular, in alcohol fuel having high conductivity. Therefore, the fluid level measurement system 100 can be suitably used to measure the level of the fuel 91 containing alcohol.

A correspondence between terms used in the first embodiment and claims are as follows. The fluid level sensor 20 corresponds to a fluid level measurement apparatus. The arm holder 23 corresponds to a rotating member. The housing 24 corresponds to a supporting member. The resistor pattern 32 corresponds to a resistive portion. The wiper 36 corresponds to a movable portion. The meter control circuit 82 corresponds to a measurement circuit. The fuel tank 90 corresponds to a container. The fuel 91 corresponds to a fluid.

### Second Embodiment

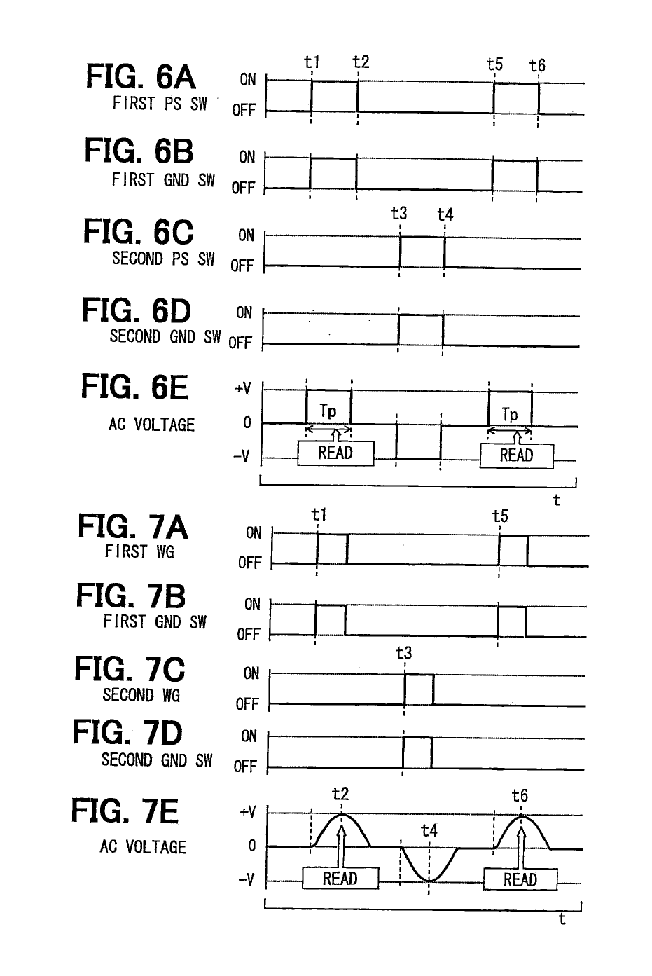

A second embodiment of the present disclosure is described below with reference to FIGS. 5 and 6A-6E. A difference of the second embodiment from the first embodiment is in that the first waveform generator 51 and the second waveform generator 61 are replaced with a first power switch 251 and a second power switch 261. Thus, according to the second embodiment, the AC voltage applied to the fluid level sensor 20 has a rectangular waveform. Like the first and second ground switches 53 and 63, the first and second power switches 251 and 261 can be FETs. The gate of the first power switch 251 is connected through the signal line 54 to the meter control circuit 82 so that the first control signal can be applied from the meter control circuit 82 to the gate of the first power switch 251. The gate of the second power switch 261 is connected through the signal line 64 to the meter control circuit 82 so that the second control signal can be applied from the meter control circuit 82 to the gate of the second power switch 261.

Another difference of the second embodiment from the first embodiment is in that the resistance surface 33 is plated with gold with a gold content of 99.9 percent or more. Alternatively, the resistance surface 33 can be coated with gold alloy with a gold content of 58.5% inclusive to 99.9% exclusive. Alternatively, the resistance surface 33 can be made of mainly gold by a method other than a plating method.

The operation of the fluid level measurement system 100 according to the second embodiment is described below with reference to FIGS. 6A-6E.

As shown in FIGS. 6A and 6B, the meter control circuit 82 keeps the first control signal supplied to the first power switch 251 and the third control signal supplied to the first ground switch 530N from the time t1 and the time t2. Accordingly, as shown in FIG. 6E, the first power switch 251 and the first ground switch 53 are kept ON so that a voltage can appear between the power terminal 25 and the ground terminal 26 of the fluid level sensor 20. Therefore, the AC voltage applied between the power terminal 25 and the ground terminal 26 of the fluid level sensor 20 has a positive peak value during the peak period Tp from the time t1 to the time t2.

Then, as shown in FIGS. 6C and 6D, the meter control circuit 82 keeps the second control signal supplied to the second power switch 261 and the third control signal supplied to the second ground switch 630N from the time t3 and the time t4. Accordingly, as shown in FIG. 6E, the second power switch 261 and the second ground switch 63 are kept ON so that a voltage can appear between the power terminal 25 and the ground terminal 26 of the fluid level sensor 20. Therefore, the AC voltage applied between the power terminal 25 and the ground terminal 26 of the fluid level sensor 20 has a negative peak value during the peak period Tp from the time t3 to the time t4.

Then, the meter control circuit 82 keeps the first control signal supplied to the first power switch 251 and the third control signal supplied to the first ground switch 530N from the time t5 and the time t6. Accordingly, the AC voltage applied between the power terminal 25 and the ground terminal 26 of the fluid level sensor 20 has the positive peak value during the peak period Tp from the time t5 to the time t6.

The meter control circuit 82 repeatedly controls the control signals in the above manner so that the AC voltage applied by the voltage application circuit 40 to the variable resistor 30 of the fluid level sensor 20 can have a rectangular waveform. The AC voltage has a zero section where the AC voltage is zero between a positive section where the AC voltage is positive and a negative section where the AC voltage is negative. The meter control circuit 82 measures the present level of the fuel 91 in the fuel tank 90 by detecting the potential of the power terminal 25 within the peak period Tp.

As described above, according to the second embodiment, the AC voltage applied to the variable resistor 30 has a rectangular waveform. Even in such a configuration, by increasing the frequency of the AC voltage, it is less likely that the ions dissolved from the contact surface 37 into the fuel 91 move far away from the contact surface 37 before the polarity of the potential of the variable resistor 30 reverses. Therefore, the dissolved ions can return to the contact surface 37, when the polarity of the potential of the variable resistor 30 reverses. Thus, the combination of the contact surface 37 made of mainly gold and the application of the rectangular AC voltage to the variable resistor 30 can effectively reduce the galvanic corrosion of the contact surface 37 while maintaining the stable contact of the contact surface 37 regardless of the reduction in the peak period Tp. Therefore, the measurement accuracy of the fluid level measurement system 100 can be maintained even after the fluid level measurement system 100 is used for a long time.

Further, according to the second embodiment, not only the contact surface 37 of the wiper but also the resistance surface 33 of the resistor pattern 32 in contact with the contact surface 37 is made mainly of gold. In such an approach, it is ensured that good conduction between the wiper 36 and the resistor pattern 32 is maintained. Accordingly, it is ensured that the waveform of the AC voltage is stable. Therefore, it is possible to reduce the galvanic corrosion of the contact surface 37 by increasing the frequency of the AC voltage. For the above reasons, the electrical resistance indicated by the fluid level sensor 20 accurately corresponds to the level of the fuel 91 even after the fluid level sensor 20 is used for a long time. Accordingly, the measurement accuracy of the fluid level measurement system 100 can be maintained even after the fluid level measurement system 100 is used for a long time.

### Third Embodiment

A third embodiment of the present disclosure is described below with reference to FIGS. 7A-7E. A difference of the third embodiment from the first embodiment is in that the AC voltage applied to the fluid level sensor 20 has a sinusoidal waveform.

The operation of the fluid level measurement system 100 according to the third embodiment is described below with reference to FIGS. 7A-7E.

As shown in FIGS. 7A and 7B, at the time t1, the meter control circuit 82 turns ON the first control signal supplied to the first waveform generator 51 and the third control signal supplied to the first ground switch 53. Thus, as shown in FIG. 7E, the AC voltage applied between the power terminal 25 and the ground terminal 26 of the fluid level sensor 20 increases in a sinusoidal manner to the positive side. The AC voltage reaches the positive peak value at the time t2.

Then, at the time t3, as shown in FIGS. 7C and 7D, the meter control circuit 82 turns ON the second control signal supplied to the second waveform generator 61 and the fourth control signal supplied to the second ground switch 63. Thus, as shown in FIG. 7E, the AC voltage applied between the power terminal 25 and the ground terminal 26 of the fluid level sensor 20 decreases in a sinusoidal manner to the negative side. The AC voltage reaches the negative peak value at the time t4. Then, at the time t5, the meter control circuit 82 turns ON the first control signal and the third control signal. Thus, as shown in FIG. 7E, the AC voltage reaches the positive peak value at the time t6.

The meter control circuit 82 repeatedly controls the control signals in the above manner so that the AC voltage applied by the voltage application circuit 40 to the variable resistor 30 of the fluid level sensor 20 can have a sinusoidal waveform. The AC voltage has a zero section where the AC voltage is zero between a positive section where the AC voltage is positive and a negative section where the AC voltage is negative. The meter control circuit 82 measures the present level of the fuel 91 in the fuel tank 90 by detecting the potential of the power terminal 25 at the time t2 and t6, where the AC voltage has the positive peak value.

As described above, according to the third embodiment, the AC voltage applied to the variable resistor 30 has a sinusoidal waveform. Even in such a configuration, by increasing the frequency of the AC voltage, it is less likely that the ions dissolved from the contact surface 37 into the fuel 91 move far away from the contact surface 37 before the polarity of the potential of the variable resistor 30 reverses. Therefore, the dissolved ions can return to the contact surface 37, when the polarity of the potential of the variable resistor 30 reverses. Thus, the combination of the contact surface 37 made of mainly gold and the application of the sinusoidal AC voltage to the variable resistor 30 can effectively reduce the galvanic corrosion of the contact surface 37 while maintaining the stable contact of the contact surface 37. Therefore, the measurement accuracy of the fluid level measurement system 100 can be maintained even after the fluid level measurement system 100 is used for a long time.

Further, according to the third embodiment, due to the sinusoidal waveform, the AC voltage has the rising time and the falling time. That is, there is a time lag when the AC voltage changes between the reference value and the peak value with reference to the reference value. In such an approach, the conduction noise and the radiation noise due to the sharply change in the AC voltage are reduced so that the meter control circuit 82 can accurately measure the level of the fuel 91. Therefore, the measurement accuracy of the fluid level measurement system 100 can be maintained high.

(Modifications)

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

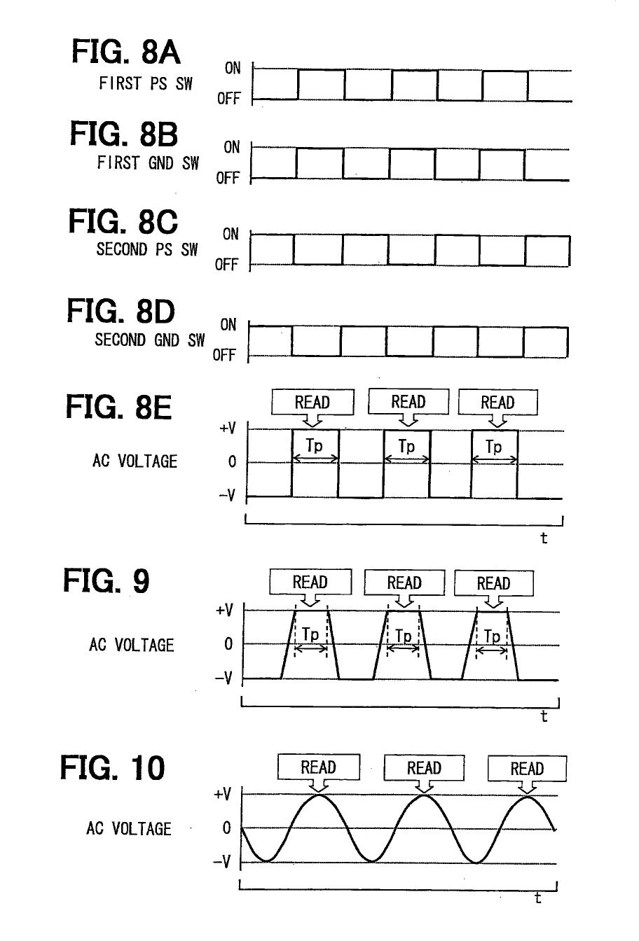

The waveform of the AC voltage applied to the variable resistor 30 of the fluid level sensor 20 is not limited to those described in the embodiments. For example, the AC voltage can have no zero section. For example, as shown in FIGS. 8A-8E, the control signals supplied to the first power switch and the first ground switch and the control signals supplied to the second power switch and the second ground switch can be alternately turned ON so that the AC voltage can have a rectangular waveform with no zero section. Alternatively, as shown in FIG. 9, the AC voltage can have a trapezoidal waveform with no zero section. Alternatively, as shown in FIG. 10, the AC voltage can have a sinusoidal waveform with no zero section.

The power switches 251, 261 and the ground switches 53, 63 are not limited to FETs. Various types of transistors can be used as these switches 251, 261, 53, and 63.

In the embodiments, the meter control circuit 82 measures the level of the fuel 91 by detecting the potential of the power terminal 25 when the AC voltage has the positive peak value. Alternatively, the meter control circuit 82 can measure the level of the fuel 91 by detecting the potential of the ground terminal 26 when the AC voltage has the negative peak value. Alternatively, the meter control circuit 82 can measure the level of the fuel 91 by detecting the potentials of the power and ground terminals 25, 26 when the AC voltage has the positive and negative peak values, respectively. Alternatively, the meter control circuit 82 can measure the level of the fuel 91 by detecting the potential of one of the power and ground terminals 25, 26 when the AC voltage is not peaked.

In the embodiments, the application of the AC voltage by the voltage application circuit 40 to the fluid level sensor 20 is controlled by the meter control circuit 82. Alternatively, the application of the AC voltage by the voltage application circuit 40 to the fluid level sensor 20 can be controlled by a circuit other than the meter control circuit 82. Further, the frequency of the AC voltage controlled by the meter control circuit 82 is not limited to those described in the embodiments. For example, the frequency of the AC voltage applied to the variable resistor 30 can exceed 50 kHz.

In the embodiments, the contact surface 37 mainly made of gold is formed by depositing metal material, containing gold as a major ingredient, on the wiper 36. A method of forming the contact surface 37 is not limited to the embodiments. For example, the metal material, containing gold as a major ingredient, can be bonded to the conductor 35 made of copper alloy by a method other than deposition. Alternatively, like the resistance surface 33, the contact surface 37 can be formed by coating an outer surface of the wiper 36 made of copper material with gold or gold alloy. Alternatively, the entire wiper 36 or the entire conductor 35 can be made of a material containing gold as a major ingredient.

In the embodiments, the voltage applied from the power supply circuit 81 to the voltage application circuit 40 is set lower than a battery voltage (e.g., 13.5 volts) of a typical vehicle. Thus, since the voltage applied to the voltage application circuit 40, i.e., the variable resistor 30 is relatively low, the galvanic corrosion can be reduced. The value of the voltage applied from the voltage application circuit 40 to the variable resistor 30 is not limited to those described in the embodiments.

The fluid level measurement system 100 can measure the level of fluid other than the alcohol fuel 91 in the fuel tank 90 of the vehicle. For example, the fluid level measurement system 100 can measure the level of brake fluid, engine coolant, or engine oil in a container of the vehicle. Attentively, the fluid level measurement system 100 can measure the level of fluid in a container of a machine other than a vehicle, such as a household appliance or a transport machine.

What is claimed is:

1. A fluid level measurement system comprising:
a fluid level measurement apparatus including a rotating member configured to rotate depending on a level of a fluid in a container, a supporting member supported by the container to rotatably support the rotating member, and a variable resistor having an electrical resistance varying depending on an angle of rotation of the rotating member;
a voltage application circuit configured to apply an alternating current (AC) voltage to the variable resistor; and
a measurement circuit configured to measure the level of the fluid based on the electrical resistance of the variable resistor, wherein
the variable resistor includes a resistive portion and a movable portion,
the resistive portion is held by the supporting member and extends around a center of rotation of the rotating member,
the movable portion is held by the rotating member and has a contact surface made mainly of gold, and
when the rotating member rotates, the movable portion moves along the resistive portion with the contact surface in contact with the resistive portion so that the electrical resistance of the variable resistor corresponds to the level of the fluid.

2. The fluid level measurement system according to claim 1, wherein
the measurement circuit measures the level of the fluid based on the electrical resistance of the variable resistor to which a peak value of the AC voltage is applied.

3. The fluid level measurement system according to claim 2, wherein
the measurement circuit controls the voltage application circuit to measure the level of the fluid based on the electrical resistance of the variable resistor to which the peak value of the AC voltage is applied.

4. The fluid level measurement system according to claim 1, wherein
the AC voltage changes between a reference value and a peak value with reference to the reference value, and
there is a time lag when the AC voltage changes between the reference value and the peak value.

5. The fluid level measurement system according to claim 4, wherein
a trajectory of the change in the AC voltage forms a line that is not perpendicular to a time axis.

6. The fluid level measurement system according to claim 4, wherein
the AC voltage has a trapezoidal waveform.

7. The fluid level measurement system according to claim 4, wherein
the AC voltage has a sinusoidal waveform.

8. The fluid level measurement system according to claim 1, wherein
the resistive portion has a resistance surface in contact with the contact surface of the movable portion, and
the resistance surface is made mainly of gold.

9. A fluid level measurement apparatus comprising:
a rotating member configured to rotate depending on a level of a fluid in a container;
a supporting member supported by the container to rotatably support the rotating member, and
a variable resistor having an electrical resistance varying depending on an angle of rotation of the rotating member, wherein
the variable resistor includes a resistive portion and a movable portion,
the resistive portion is held by the supporting member and extends around a center of rotation of the rotating member,
the movable portion is held by the rotating member and has a contact surface made mainly of gold,
when the rotating member rotates, the movable portion moves along the resistive portion with the contact surface in contact with the resistive portion so that the electrical resistance of the variable resistor corresponds to the level of the fluid, and
the fluid level measurement apparatus is connectable to a voltage application circuit configured to apply an alternating current (AC) voltage to the variable resistor and a measurement circuit configured to measure the level of the fluid based on the electrical resistance of the variable resistor.
